(19) United States
(12) Patent Application Publication
(10) Pub. No.: US 2021/0199279 A1
(43) Pub. Date: Jul. 1, 2021

(54) Self-Lit Footlocker Face Indicia

(71) Applicant: Sam Allen, Maypearl, TX (US)

(72) Inventor: Sam Allen, Maypearl, TX (US)

(21) Appl. No.: 16/731,587

(22) Filed: Dec. 31, 2019

(51) Int. Cl. F21V 33/00; A47F 3/00; F21S 4/24

(52) U.S. Cl. CPC F21V 33/0012; F21Y 2115/10; F21S 4/24; A47F 3/001

(57) ABSTRACT

A door in a locker with a textured substrate panel that has a top edge, side edge, and a texture or a patterned portion between the top edge and the side edge that creates a uniform distribution of light from a light source positioned relative to illuminated indicia. The top edge and the side edge are generally straight connected by a corner. Illuminated indicia is positioned on a surface of a substrate panel relative to the top edge, the side edge, the corner, or a combination of them. The position of the illuminated indicia includes locating it on an exterior plane, a posterior plane, or an interior plane relative to a surface of the substrate panel.

### BACKGROUND

### 1. Field of the Invention

The present invention relates in general to the field of face indicia for lockers.

### 2. Description of Related Art

Lockers for athletic gear, school supplies, tools, guns, ammo, and for other storage generally have multiple access doors. Typically, signs or other illuminated panels include a glass or plastic panel, having one or more light sources incorporated behind the panel to illuminate a logo, instructions, or insignia placed on the panel. Some of these illuminated panels use a grid-like etching, attempting to distribute the illumination from the light source over the panel. However, the grid-like etching creates non-uniform, intensified regions of illumination along etch lines and etched intersections, as opposed to a desired uniform distribution of light. Lockers generally do not incorporate face-lit panels, however, those that do incorporate them fail to create low-cost uniform distributions of light and/or a more selectively dictated illumination effect. The panels that are face-lit often rely on an indirect light source, and are otherwise not self-lit. Thus, there exists significant room for improvement in the art for overcoming these and other shortcomings of face-lit lockers.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1 through 4 are elevation views of lockers incorporating the illuminated indicia panel according to the present application;

FIG. 5A is an enlarged, exploded view of a substrate panel and a border light strip according to the present application;

FIG. 5B is side view of a substrate panel from FIG. 5A according to the present application;

FIG. 6A is an enlarged, exploded view of a substrate panel and a border light strip according to the present application;

FIG. 6B is side view of a substrate panel from FIG. 5A according to the present application;

FIG. 7 is an enlarged, exploded view of a substrate panel with edge lighting according to the present application;

FIG. 8 is an enlarged, exploded view of a substrate panel with back lighting according to the present application;

FIGS. 9 through 12 are enlarged, exploded views, of front surfaces of treated illuminated panels with texture and/or etch patterns according to the present application;

FIGS. 13A through 13C are enlarged, exploded views of texture and/or etch patterns for indicia; and

FIG. 14 is a method of forming an illuminated panel according to the present application.

While the assembly of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the self-lit footlocker with face indicia are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

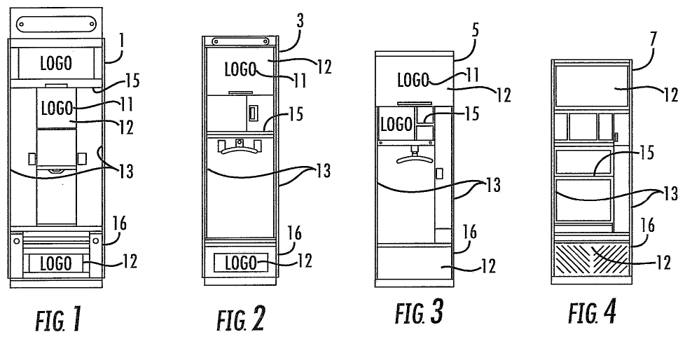

Referring now to FIGS. 1 through 4 in the drawings, four configurations of lockers 1, 3, 5, 7, each having one or more illuminated indicia 11 incorporated within one or more panels 12 according to the present application are illustrated. As can be seen, each locker 1, 3, 5, 7 comprises a pair of upstanding sidewalls 13 that generally define the extent of the locker. Each locker may be installed adjacent to another, similar or identical locker, with its rear against a wall, and its front facing the interior of the locker room.

Between the sidewalls 13 of each locker 1, 3, 5, 7, a plurality of compartments 15 are defined by shelves or other horizontally extending surfaces or platforms. The plurality of compartments includes a foot compartment 16. The foot compartment 16 is at the foot-level, or is intended to house foot gear, such as cleats, boots, ice skates, and similar foot gear. Multiple additional sidewalls may be placed between the “main” or exterior sidewalls 13 to define compartments along with horizontal shelves and the like. As used herein, “sidewall” or “sidewalls” may refer to either “main” sidewalls 13 or other sidewalls arranged between the “main” sidewalls. Each compartment 15 may be sized and otherwise configured for storage of clothing, sporting equipment, ammunition, hunting equipment, construction equipment, police and military equipment, or other items, and may include one or more doors, which may be lockable.

Each of the lockers 1, 3, 5, 7 also incorporates one or more panels 12 with illuminated indicia 11 (by illuminating a panel 12) according to an embodiment of the present application. In each example, an illuminated panel 12 is connected to a power source 14 and takes the form of a door giving access to a compartment behind the door, but the illuminated panel 12 may be merely structural or cosmetic and have no other function. The indicia 11 may take the form of graphic art (the paw print and wildcat profile of FIGS. 1 and 2), lettering or logos comprised of stylized lettering (the UK of FIG. 3), or printed artwork on a single, monolithic illuminated panel 12 as in the case of FIG. 4 (artwork is omitted for clarity).

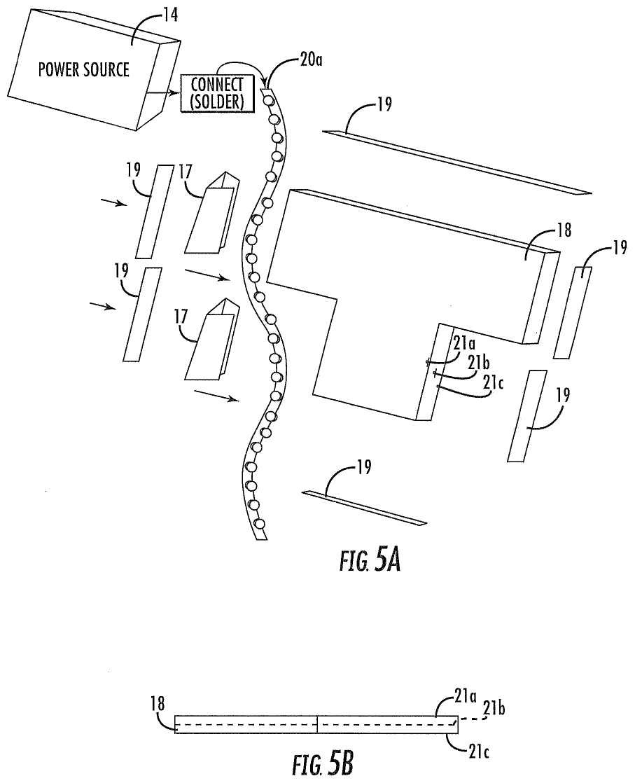

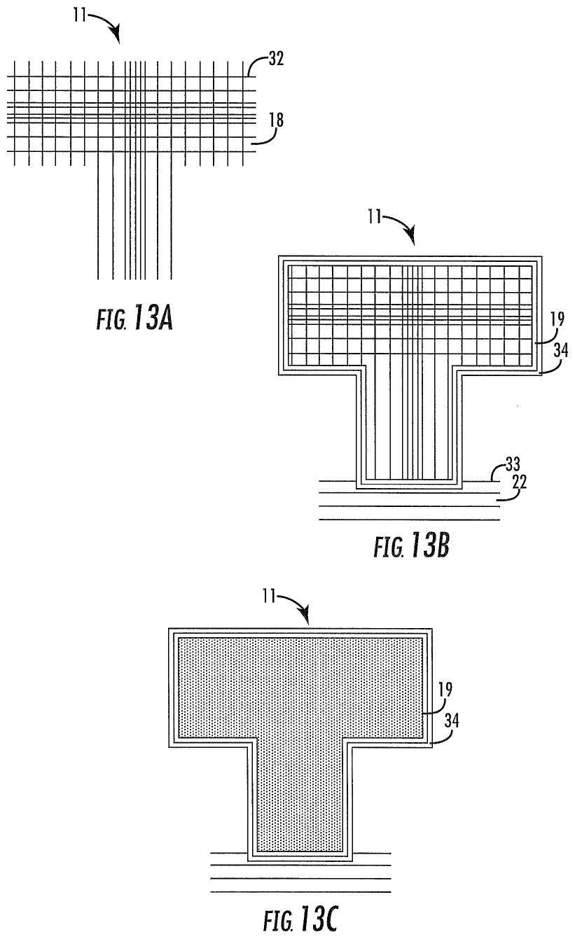

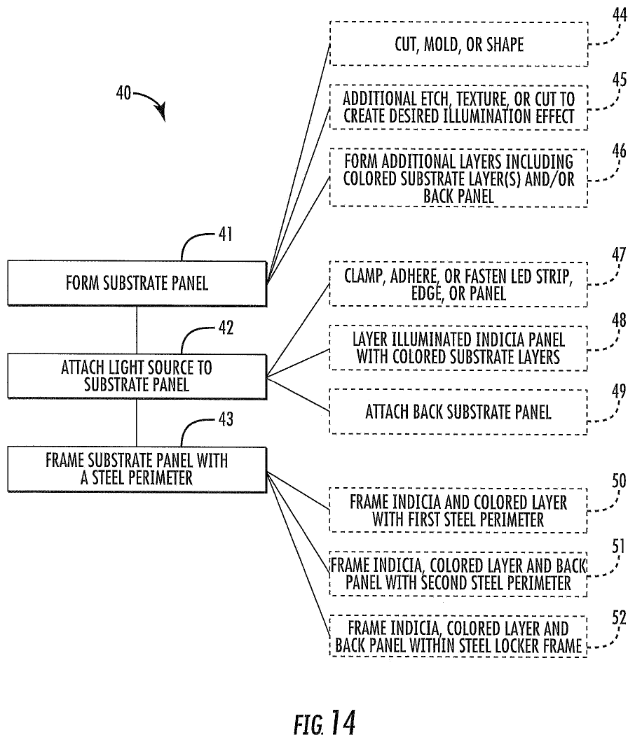

Referring now also to FIG. 5A, indicia 11 is combined with an edge light 20, such as flexible strip light 20a, and attachment means 17, such as an edge clamp, as illustrated. The combination of a light source, the attachment means, and a power source creates an illuminated panel 12. The length of strip light 20a varies depending on the dimensions of the indicia substrate panel 18. The attachment means 17 includes adhesives, fasteners, edge clamps, or combinations thereof. In a preferred embodiment, strip light 20a is placed around the outer edge of indicia substrate panel 18 and attached with the edge clamp. The indicia substrate panel 18 is a layer of clear, transparent, or translucent material and is shaped into a specified indicia, such as the letter “T”. The translucent material includes, but is not limited to, glass, plastic, quartz, and acrylic materials. In a preferred embodiment, the indicia substrate panel 18 is made of an acrylic material, such as Plexiglas, Lucite, Acrylite, and Perspex. The indicia substrate panel 18 may also include texturing, patterning, or another colored substrate layer incorporated on top or underneath the panel (see FIGS. 13A through 13C below).

In a preferred embodiment, a metal border or frame 19 is positioned around the indicia substrate panel 18 and the attached strip light 20a. It is noted that although steel perimeter 19 is depicted as multiple, discrete framing pieces, the steel perimeter 19 can also be a continuous metal sheet or strip surrounding the indicia substrate panel 18 and the attached strip light 20a. Further, although the term “steel perimeter” is used, other materials, such as aluminum, plastic, fiber glass, and similar low-cost, light-weight opaque materials may be used. In at least one embodiment, the steel perimeter 19 separates the light from the illuminated indicia panel from a second, surrounding illuminated panel.

The edge light 20 is comprised of multiple, discrete lights, such as incandescent, fluorescent, or light-emitting diode (LED) lights, but preferably includes LED lights. In another embodiment, edge light 20 includes a continuous strip of light, or at least one single or unibody edge lighting element, such as an LED strip light.

Edge light 20 includes a light source and its appropriate wiring for electric power. Edge light 20 may be coupled (e.g., as with soldering) either to a power source 14 contained elsewhere in or external to the locker or within the enclosure formed by the main sidewalls 13. The power source 14 may include dimmers, timers, switches and the like to turn off, dim, blink or otherwise manipulate the lighting emitting from edge light 20. The power source 14 may be a battery, a generator, or a direct AC/DC power source. Preferably, the lighting element is a strip or edge array of a plurality of white or colorless LEDs molded or otherwise formed into an exterior, interior, or posterior border, as illustrated. Discrete LEDs, LED tubes, continuous LED strips, incandescent, fluorescent, or other lighting elements may be appropriate. Colors other than white may be utilized, including combinations of colors. In a preferred embodiment, the LEDs or other lighting elements provides illumination for “edge lighting” or transmitting and distributing light along the edges of translucent or transparent portions, sheets, layers, or panels secured to a door of a compartment 15 and/or 16. In another embodiment, the LEDs or other lighting elements provides illumination for “back lighting”, such as an LED panel positioned behind an acrylic sheet.

In at least one embodiment, the light source is activated by a motion sensor. For example, active radio or microwave sensors, passive infrared sensors, or a combined hybrid motion sensor is used to activate edge light 20.

In at least one embodiment, the indicia 11 includes a texture or a pattern. The texture or patter is formed by engraving, etching, laser engraving, or a combination thereof to correspond to the outline, lettering, or the graphic matter to be illuminated. In a preferred embodiment, the indicia may be a combination of graphic art, lettering, stylized lettering, or the like by cutting layers of glass or other substrates to correspond to the desired lettering, graphic art, or stylized lettering. In other embodiments, the substrate layers forming indicia may be chemically, mechanically, or magnetically adhered to an illuminated panel 12.

Referring now also to FIG. 5B, in a preferred embodiment, indicia substrate panel 18 incorporates the texture or pattern at a predetermined location relative to a surface of the panel. For example, texture or pattern is formed on an exterior plane 21a, or top surface of the panel 18. Preferably the exterior plane 21a is parallel with the top or front surface of the indicia substrate panel 18.

In another embodiment, the texture or pattern is formed on an interior, or inside, plane 21b of the panel 18. A laser etching process, discussed below, enables locating and forming the texture or pattern at or on plane 21b. In another embodiment, indicia 11 is formed on a posterior, bottom, or back plane 21c of the panel 18.

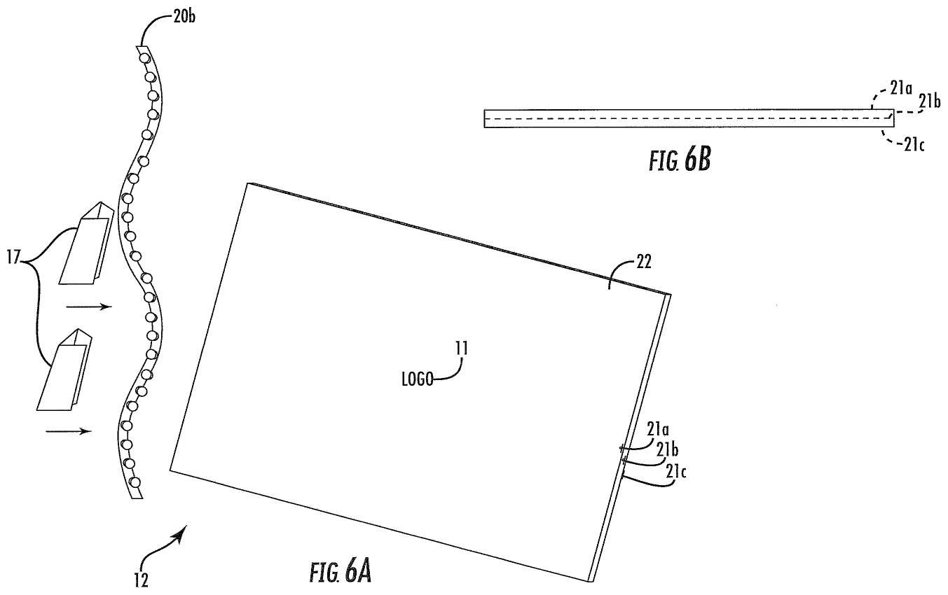

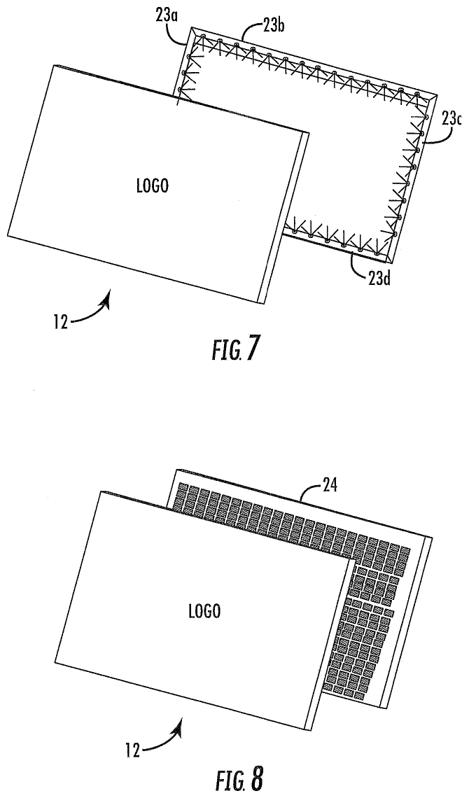

Referring now also to FIGS. 6A and 6B, in at least one embodiment, the indicia 11 is formed on a substrate panel by engraving, etching, laser engraving, or a combination thereof to correspond to the outline, lettering, or the graphic matter to be illuminated. The indicia 11 is formed on or in the surrounding substrate panel 22, such as on a surface corresponding to plane 21a. Strip light 20b is attached to the perimeter of the panel to form an illuminated panel 12. A steel perimeter 19 (see FIG. 5A) may also be positioned around all or a portion of the illuminated panel 12.

In other embodiments, the substrate layers forming indicia may be chemically, mechanically, or magnetically adhered to an illuminated panel 12. It is further noted that although substrate panel 22 is depicted as having only straight edges, in at least one embodiment, substrate panel 22 includes one or more curved edges.

Referring now also to FIG. 7, a rigid edge light 23 is positioned relative to an edge of the panel 22, in lieu of strip light 20b, to direct light towards and illuminate the indicia. In a preferred embodiment, the rigid edge light 23 is positioned behind an edge of the panel 22; however, at least one embodiment includes positioning the rigid edge light 23 in front of a panel 22. In a preferred embodiment, an illuminated panel 12 incorporates multiple rigid edge lights connected together around a perimeter of panel 22, such as edge lights 23a, 23b, 23c, and 23d.

In embodiments using layered sheets of glass to form indicia 11 a single-color embodiment (as in the case of the paw of FIG. 1), only a single sheet of appropriately colored acrylic may be required and is dimensioned slightly larger than an aperture or outline to permit it to be secured to the reverse side of a door of a compartment by adhesives or fasteners. In multi-colored embodiments, two or more sheets of differently colored acrylic adhered together may be necessary. For example, in the UK embodiment of FIG. 3, a sheet of white acrylic is cut coextensive with and in the same outline as the aperture, but 0.25 inch smaller. The white sheet then is adhered to a blue sheet dimensioned to be secured to the reverse of the door. This produces an illuminated UK logo of white-outlined blue letters.

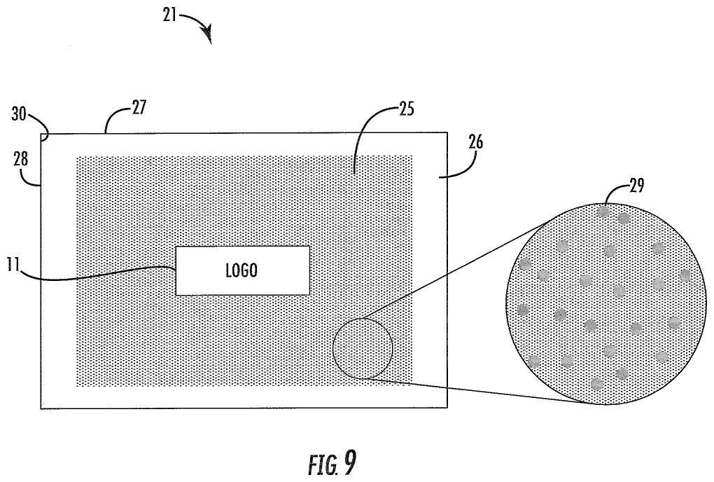

Referring now also to FIG. 8, in embodiments using the single-layer monolithic panel (FIG. 4), a single sheet of acrylic, preferably translucent or light-transmitting white, may be mounted within a steel perimeter frame by adhesives or fasteners. This combination then forms the door or panel. The panel 22 and a back light LED panel 24 are secured to a frame behind an acrylic sheet to form an illuminated panel 12. A removable graphics sheet, with printed or otherwise-applied graphics thereon, may be secured to the front of the acrylic sheet. The acrylic sheet is a translucent or transparent sheet (or may be opaque and contain graphic cut-outs or outlines). In at least one embodiment, the acrylic sheet is magnetically secured to a steel frame of a compartment door. This embodiment permits the graphics to be changed simply by removing and replacing the graphics sheet.

Graphics may also be implemented by combinations of the embodiments illustrated above, e.g. a translucent panel (FIG. 4) may be combined with a multi-layer graphic (FIGS. 2 and 3). The graphics may include an LED panel that is capable of displaying rudimentary or even full-motion or television-quality graphics. Such a panel may include the ability to display text banners and the like that are changeable via a programming module.

In a preferred embodiment, the illuminated panel 12 is incorporated in a door or a drawer of a foot compartment 16 of a locker. In other embodiments, the illuminated panel is incorporated in, or as, a door to any compartment of a locker. The illuminated panel 12 of the foot compartment 16 may include positive or negative lighting. For example, with negative lighting, the entire surface of the panel 12 is textured except for the letters or indicia 11, which clearly transmits light as through a glass or acrylic substrate. By way of another example, the indicia 11 may be textured using a first texture pattern that creates a more uniform distribution of light, while the remainder of the panel may be textured using a second texture pattern that is less uniform. For instance, the “TIGERS” indicia from locker 1 of FIG. 1 may be formed using a dot pattern, whereas the dark portions of panel 12 may be formed using a grid-like line pattern. By way of another example, the darkened portions of panel 12 in FIG. 1 may receive an acrylic paint, or another opaque texture that restricts the transmission of light, whereas the indicia 11 forming the word “TIGERS” may comprise a dot texture, a grid pattern, or no texture/pattern at all. With positive lighting, the darkened portions of panel 12 in FIG. 1 may receive the dot texture or no texture at all, while the indicia 11 forming the word “TIGERS” is darkened with paint or receives a non-uniform light distribution pattern.

Generally, with negative lighting the indicia on the panel transmits more light, or at least transmits a more uniform distribution of light, than the portions of the substrate panel surrounding it. With positive lighting, the portions of the substrate panel that surround the indicia transmit more light, or the more uniform distribution of light, than the indicia. In a preferred embodiment, the illuminated panel 12 incorporates negative lighting.

Referring now also to FIG. 9, a plane 21 parallel with a front surface of a substrate panel 22 is treated or texturized according to the present application. Treated substrate panel 22 comprises a texturized portion 25 and an untreated portion 26. Treated substrate panel 22 comprises a top edge 27, a side edge 28, and a texture 29 applied to, formed in, or formed on the texturized portion 25. The texturized portion 25 is formed in/on the substrate panel 22 relative to the top edge 27 and the side edge 28. For example, the texturized portion 25 may be centered relative edges of the panel, such as the top edge 27 and the side edge 28. The texturized portion 25 may also be left-aligned, right-aligned, off-centered, or a combination of alignments relative to either the top edge 27, the side edge 28, or the corner 30.

In other embodiments, the plane 21 may be at interior or exterior locations of the substrate panel 22. For example, the texture 29 may be formed on the interior plane 21b or the exterior plane 21c of panel 22. The interior plane 21b is a plane that is located at and runs laterally along a center axis of the substrate panel 22. It is noted that the centered location is not limiting, but it ensures maximum integrity of the substrate panel despite laser etching occurring at the interior of the panel. The exterior plane 21c is parallel with a back surface of the substrate panel and is generally located relative to the back surface.

As shown in FIG. 9, top edge 27 and side edge 28 are generally straight. Top edge 27 and side edge 28 are connected by a straight corner 30. In a preferred embodiment, straight corner 30 is replaced, or rounded, to form a beveled or curved corner.

Often substrate panels used in face-lit lockers are etched with a series of longitudinal lines and a series of lateral lines, creating a grid-like pattern in the panel. Since the grid-like pattern includes lines having a discrete and continuous depth, a light-channeling effect can occur. The light-channeling effect can cause light distortions at line intersections, resulting patchiness in panel presentation, dark spots, and other undesirable effects. Thus, although the grid-like pattern is symmetrically, uniformly, or non-randomly distributed in a substrate panel, it creates an undesirable non-uniform distribution of light.

In a preferred embodiment, texture 29 is formed from a randomized distribution of dots and/or micropores including circular, oblong, semi-spherical, or a combination of shapes sprayed, etched, spread, ground (as with diamond grinding), or otherwise distributed over, under, or through texturized portion 25. The dimensions of the dots forming the texture are small enough (e.g., one to 5,000 micrometers in diameter) along any axis such that light-channeling is minimalized, yet distributed over a sufficient surface area such that uniform light distribution throughout the texturized portion is substantially obtained. The dots can include indentations, such as with etching, or raised textures formed as with acrylic resins and/or cements placed on top of the substrate panel and allowed to cure.

Referring now also to FIGS. 10 through 12, in another embodiment, texture 29 includes a first pattern and a second pattern. For example, texture 29 includes dots formed on or in the same plane as longitudinal and/or lateral etching, thereby creating different areas of light emphasis. For instance, a first area of light emphasis 31a is formed using a dot pattern engraving and a second area of light emphasis 31b is formed using both lateral and longitudinal line etching/engraving. Preferably, the first area of light emphasis 31a differs from the second area of light emphasis 31b at least in that the first area of light emphasis 31a creates a more uniform light distribution than the second area of light emphasis 31b. The distribution or uniformity of the light may be measured by a photometer.

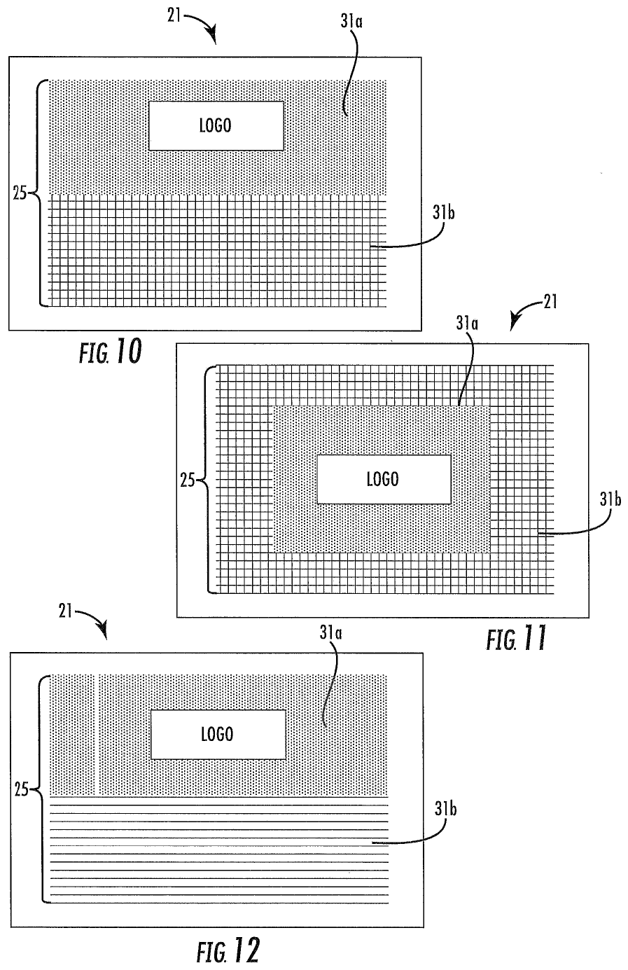

Referring to FIGS. 11 and 12, the different areas of emphasis may vary in location and in etching and/or engraving pattern. For example, the indicia 11 is the desired focal point of panel 12, and therefore may be directly surrounded by texture 29, and then surrounded indirectly by the longitudinal and lateral etching, as depicted in FIG. 11. The longitudinal and lateral etched portion may include only a single directional type of etching/engraving, such as the lateral etching depicted in FIG. 12. Different patterns and arrangements of etching, including etching or engraving of indicia 11, will be recognized by those of skill in the art, and are encompassed by the features of the present application.

In a preferred embodiment, texturized portion 25 is preferably formed using an etching process. For example, an acid, such as hydrofluoric acid, hexaflurosilicic acid (H₂SiF₆), acidulated phosphate fluoride (APF), and ammonium hydrogen difluoride, is distributed over a substrate panel to wet etch the panel and create the texturized portion. Other materials, such as creams, caustics, abrasives, and combinations thereof, may be used in the wet etching processes disclosed herein. By way of another example, plasma etching and/or abrasives are used to dry etch the substrate panel and form the texture of randomized dots.

In another embodiment, an interior or sub-surface portion of the substrate panel is engraved using a laser process and system. For example, the system includes a laser diode, and the process includes importing a mesh file or a JPEG file that has been 3-D formatted as a matrix of dots to be etched within an interior of the glass. The process further includes establishing a focal point for the laser diode at a point that falls within the interior of the glass. In this embodiment, the quality of the glass used increases at least with respect to optical clarity. For example, an optical crystal from 0.5 inches to 3 inches in thickness may be used in this embodiment. A size of the dots formed using sub-surface laser engraving are approximately 3,700 to 4,700 micrometers in diameter.

It is noted that although randomized distributions of dots are discussed as forming the texturized portion 25 of a substrate panel, other dot distributions are encompassed herein. For example, plasma etching may result a non-random pattern of dots formed in glass, creating a sort of dot matrix.

Referring now also to FIGS. 13A through 13C in the drawings, the logo or indicia 11 is illustrated as a letter “T”, formed using a texturized or etched pattern 32 on a substrate panel 18 that is also in the shape of the letter “T”. The texturing or patterning 32 is performed relative to one or more edges of the substrate panel 18, and may be centered, left-offset, right-offset, left-aligned, right-aligned, or combinations thereof. It is noted that although the substrate indicia panel 18 is depicted having straight lines forming a “T”, other indicia including letters with curved lines, such as the letter “D”, may also be formed.

In a preferred embodiment, the texturing or patterning 32 of the indicia 11 may occur, as in FIG. 13A, prior to the texturing or patterning 33 of a surrounding substrate panel 22, as in FIG. 13B. The surrounding substrate panel 22 includes a cut-out portion 34 in the shape of the letter “T” slightly larger in dimension than the T-shaped indicia substrate panel 18. The T-shaped panel 18, including the attached light strip, is inserted into the cut-out portion of panel 22. In at least one embodiment, the surrounding substrate panel 22 is incorporated with a back lighting LED panel 24 that is in the associated compartment or another portion of the locker. In a preferred embodiment, the illuminated T-shaped panel is framed by steel perimeter 19.

In at least one embodiment, the pattern on indicia 11 may be a non-uniform distribution of gridlines, as in FIGS. 13A and 13B. In a preferred embodiment, the indicia 11 is texturized with a dot pattern, as in FIG. 13C. The dot pattern may be uniformly distributed dots or non-uniformly distributed dots, and positioned on the interior, exterior, or posterior of the substrate panel depending on the desired distribution of illumination.

Referring now also to FIG. 14, a method 40 of forming an illuminated panel for a face-lit foot locker that is self-lighting is illustrated. Step 41 includes forming a substrate panel. For example, a clear (non-colored), transparent, or translucent substrate panel 18 may be etched or engraved to place the desired pattern or texture thereon/therein.

Step 42 includes attaching a light source to the substrate panel. For example, a flexible strip light 20 may be clamped around an edge of the acrylic sheet formed in Step 41. Step 42 includes attaching a power source to the light source, or at least attaching a connector that interfaces with the power source, such as wiring, to the light source. The attachment is preferably by soldering, but includes other electrical attachment means, such as conductive adhesives, solderless headers, clip wires, splicing leads, and combinations thereof.

Step 43 includes framing the substrate panel with a steel perimeter. For example, the substrate panel 18 may be framed in a steel border/frame.

In a preferred embodiment, the method 40 includes additional steps or sub-steps. For example, step 41 includes steps 44, 45, and 46; step 42 includes steps 47, 48, and 49; and step 43 includes steps 50, 51, and 52.

Step 44 includes cutting a T-shape from an acrylic sheet. By way of another example, step 44 includes molding or shaping the T-shaped indicia from an acrylic resin.

Step 45 includes additional texturing, patterning, or cutting to create the desired illumination effect. For example, the surrounding panel 22 may be patterned or etched.

Step 46 includes forming additional substrate layers. For example, a colored T-shaped substrate indicia panel 18 may be formed and/or etched. By way of another example, a graphics sheet or a back LED panel may be formed and/or assembled.

Step 47 includes attaching additional light sources to one or more substrate panels. For example, light strip 20b may be attached around the surrounding panel 22. In at least one embodiment, Step 47 is optional, and includes attaching the back LED panel to the illuminated panel 12 formed from a single-layer substrate indicia panel 18. Step 47 is optional because not all embodiments disclosed herein use the LED back lighting panel 24. Step 47 may also be performed in a different order if a multi-layer substrate panel 18 (e.g., clear and colored layers) is used to form an illuminated panel.

Step 48 includes layering one or more substrate panels or layers with at least one additional substrate panel or layer. For example, a colored T-shaped substrate indicia panel 18 may be layered on top of the clear substrate panel formed in Step 41. By way of another example, a graphics sheet or a back LED panel may be layered with an illuminated panel 12.

Step 49 includes clamping the back-most substrate panel/layer together with the first substrate panel. For example, a colored substrate indicia panel 18 may be the back most substrate panel and is clamped to the clear substrate indicia panel 18.

Step 50 includes framing the indicia with a first steel perimeter. For example, the clear T-shaped substrate panel 18 layered with the colored T-shaped substrate panel 18 is framed with the first steel perimeter. The first steel perimeter seals the light from the indicia substrate panel(s), containing it to those substrate panels and preventing further transmission of light to surrounding substrate panels.

Step 51 includes framing the illuminated panel with a second steel perimeter. For example, the framed clear and colored substrate panels 18 are inserted into a cut-out of the surrounding substrate panel 22. The surrounding substrate panel is then framed with a second steel perimeter 19 that encompasses the attached strip light 20b and the perimeter of the surrounding substrate panel 22. Step 51 includes attaching a cover plate over the indicia substrate panels and the surrounding substrate panel.

Step 52 includes framing the illuminated panel within the steel perimeter of the locker. For example, after the surrounding substrate panel is framed, the multiple substrate layers and cover plate are sealed by fastening the illuminated panel to foot compartment 16 within the main sidewalls 13. In a preferred embodiment, at least steps 44-46′ of method 40 are repeated to form other letters (“I”, “G”, “E”, “R”, and “S”) of the Clemson Tigers indicia of locker 1. In another embodiment, the colored substrate indicia panel 18 is orange and the steps form a single letter “T”, such as in the logo for the Tennessee Volunteers. Step 52 also includes activating the power source such that the indicia is illuminated or the timers, dimmers, and motion sensors are activated.

It is apparent that an assembly with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A self-lit door in a locker, comprising:
a substrate panel comprising:
a top edge;
a side edge; and
a cut-out portion having a selected geometrical shape;
an indicia substrate panel configured to be inserted into the cut-out portion;
a strip light attached to an edge of the indicia substrate panel; and
a frame surrounding the indicia substrate panel;
wherein the indicia substrate panel comprises:
a texture formed from a non-uniform distribution of dots at a selected distance from the top edge and the side edge;
wherein the top edge and the side edge are generally straight and are connected by a corner; and
wherein the texture is formed on an exterior plane of the substrate panel.

2. (canceled)

3. The self-lit door of claim 1, further comprising a texture formed from a uniform distribution of dots on or in a second substrate panel.

4. The self-lit door of claim 1, further comprising:
a second substrate panel comprising:
a second top edge;
a second side edge; and
a second texture formed from a non-uniform distribution of dots at a selected distance from the second top edge and the second side edge.

5. The self-lit door of claim 4, further comprising:
a flexible LED strip light attached around a perimeter of the second substrate panel.

6. The self-lit door of claim 5, further comprising:
a steel perimeter framing the flexible LED strip light and at least one of the first substrate panel and the second substrate panel.

7. The self-lit door of claim 6, further comprising:
a power source connected to at least one of the edge light and flexible LED strip light;
wherein the second substrate panel forms an illuminated indicia.

8. A self-lit door in a locker, comprising:
a substrate panel comprising:
a top edge;
a side edge;
a cut-out portion having a selected geometrical shape;
an indicia substrate panel configured to be inserted into the cut-out portion;
a strip light attached to an edge of the indicia substrate panel; and
a frame surrounding the indicia substrate panel;
wherein the indicia substrate panel comprises:
a pattern formed from a uniform distribution of dots at a selected distance from the top edge and the side edge;
wherein at least one of the top edge and the side edge are generally straight;
wherein the top edge and the side edge are connected by a corner;
wherein the pattern is formed on an interior plane of the substrate panel.

9. (canceled)

10. The self-lit door of claim 8, further comprising a texture formed from a non-uniform distribution of dots on or in a second substrate panel.

11. The self-lit door of claim 8, further comprising:
a second substrate panel comprising:
a second top edge;
a second side edge; and
a second pattern formed from a uniform distribution of dots at a selected distance from the second top edge and the second side edge.

12. The self-lit door of claim 11, further comprising:
a second flexible edge light attached around a perimeter of the second substrate panel.

13. The self-lit door of claim 12, further comprising:
a first steel perimeter framing the second flexible edge light and the second substrate panel; and
a second steel perimeter framing the first flexible edge light and the first substrate panel.

14. The self-lit door of claim 13, further comprising:
a power source connected to the first flexible edge light and to the second flexible edge light;
wherein the second substrate panel forms an illuminated indicia panel.

15. A method for illuminating indicia of a self-lit locker, comprising:
forming a first substrate panel of the self-lit locker having:
a top edge;
a side edge;
a back surface;
a cut-out portion having a selected geometrical shape;
an indicia substrate panel configured to be inserted into the cut-out portion; and
a first pattern formed at a selected distance from the top edge and the side edge;
attaching a light source to abut at least one of the top edge, the side edge, and a back surface of the first substrate panel; and
framing the light source and the first substrate panel with an opaque perimeter.

16. The method of claim 15, further comprising:
soldering a connection between a power source and the light source; and
wherein the light source comprises a flexible LED light strip.

17. The method of claim 15, further comprising:
forming a second substrate panel having a second pattern formed therein or thereon;
wherein the first pattern comprises a dot pattern.

18. (canceled)

19. The method of claim 17, further comprising:
sealing at least one of the first substrate panel and the second substrate panel.

20. The method of claim 19, wherein the step of sealing at least one of the first substrate panel and the second substrate panel comprises framing the second substrate panel by attaching a steel perimeter around the second substrate panel and a cover plate over the first substrate panel and the second substrate panel;
the method further comprising:
fastening the cover plate, first substrate panel, and second substrate panel to a compartment of a locker; and
activating a power source connected to the light source.
